(19) United States
(12) Patent Application Publication
(10) Pub. No.: US 2024/0219763 A1
(43) Pub. Date: Jul. 4, 2024

(54) DISPLAY APPARATUS

(71) Applicant: Coretronic Corporation, Hsin-Chu (TW)

(72) Inventors: Ming-Hsiung Fan, Hsin-Chu (TW); Wen-Pao Tsai, Hsin-Chu (TW); Yi-Cheng Lin, Hsin-Chu (TW); Chih-Yang Wang, Hsin-Chu (TW)

(73) Assignee: Coretronic Corporation, Hsin-Chu (TW)

(21) Appl. No.: 18/389,807

(22) Filed: Dec. 20, 2023

(30) Foreign Application Priority Data
Dec. 28, 2022 (CN) 202211695665.X

(51) Int. Cl. G02F 1/1333; G06F 3/041

(52) U.S. Cl. CPC G02F 1/13338; G06F 3/0412

(57) ABSTRACT

A display apparatus, including a first electrically controlled liquid crystal cell and a second electrically controlled liquid crystal cell, is proposed. The first electrically controlled liquid crystal cell includes a first substrate, a second substrate, a first liquid crystal layer, and a touch electrode layer. The first liquid crystal layer and the touch electrode layer are disposed between the first substrate and the second substrate. The second electrically controlled liquid crystal cell is disposed on one side of the first substrate of the first electrically controlled liquid crystal cell and overlapping the first electrically controlled liquid crystal cell. A spacer layer or a conductive layer is disposed between the first electrically controlled liquid crystal cell and the second electrically controlled liquid crystal cell, and the spacer layer or the conductive layer is disposed on a surface of the first substrate facing away from the first liquid crystal layer.

### CROSS-REFERENCE TO RELATED APPLICATION

This application claims the priority benefit of China application serial no. 202211695665.X, filed on Dec. 28, 2022. The entirety of the above-mentioned patent application is hereby incorporated by reference herein and made a part of this specification.

### BACKGROUND

### Technical Field

The disclosure relates to a display apparatus, and more particularly to a display apparatus with touch functionality.

### Description of Related Art

To make a touch display apparatus with an anti-peeping function, a technical solution of disposing an electrically controlled privacy sheet between the touch display panel and the backlight module is proposed. However, when being touched, the coupling capacitance between the touch electrode layer in the touch display panel and the electrode layer in the electrically controlled privacy sheet is easily changed due to the deformation of the touch display panel by touch pressure, resulting in a spread of intensity of touch sensing that is identified by the system as an abnormal or invalid touch.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a display apparatus with better touch accuracy.

The other objectives and advantages of the present invention can be further understood from the descriptive features disclosed in the present invention.

In order to achieve one or part or all of the above purposes or other purposes, an embodiment of disclosure proposes a display apparatus. The display apparatus includes a first electrically controlled liquid crystal cell and a second electrically controlled liquid crystal cell. The first electrically controlled liquid crystal cell includes a first substrate, a second substrate, a first liquid crystal layer, and a touch electrode layer. The first substrate and the second substrate are overlapped with each other. The first liquid crystal layer is disposed between the first substrate and the second substrate. The touch electrode layer is disposed between the first substrate and the second substrate. The second electrically controlled liquid crystal cell is disposed on one side of the first substrate of the first electrically controlled liquid crystal cell and overlapping the first electrically controlled liquid crystal cell. A spacer layer or a conductive layer is disposed between the first electrically controlled liquid crystal cell and the second electrically controlled liquid crystal cell, and the spacer layer or the conductive layer is disposed on a surface of the first substrate facing away from the first liquid crystal layer.

Based on the above, in the display apparatus of an embodiment of the disclosure, the touch electrode layer is disposed inside the first electrically controlled liquid crystal cell. By the configuration of the spacer layer or the conductive layer between the first electrically controlled liquid crystal cell and the second electrically controlled liquid crystal cell, a change of a coupling capacitance of the touch electrode layer and the second electrically controlled liquid crystal cell when being touched caused by a deformation of the first electrically controlled liquid crystal cell may be avoided, which helps to improve the touch accuracy of the display apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic view of a display apparatus according to the first embodiment of the disclosure.

FIG. 2 is a cross-sectional schematic view of a display apparatus according to the second embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

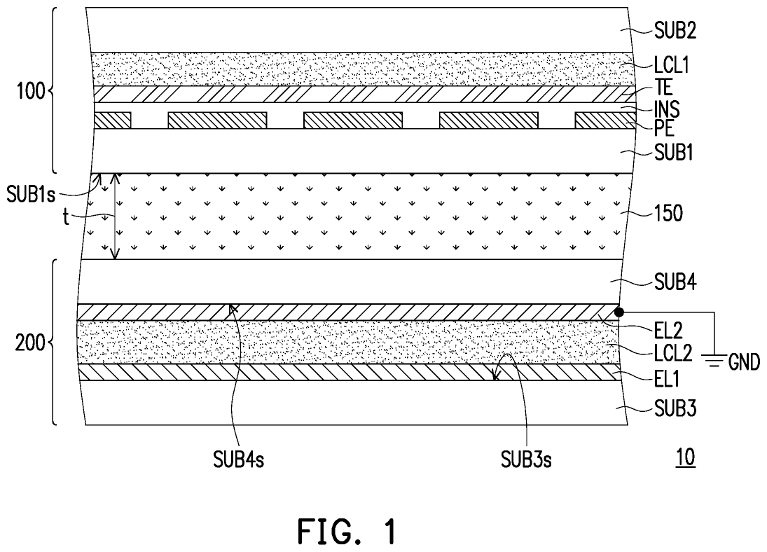

FIG. 1 is a cross-sectional schematic view of a display apparatus according to the first embodiment of the disclosure. Referring to FIG. 1, a display apparatus 10 includes a first electrically controlled liquid crystal cell 100 and a second electrically controlled liquid crystal cell 200. In this embodiment, the first electrically controlled liquid crystal cell 100 is, for example, a touch display panel, which may include a first substrate SUB1, a second substrate SUB2, a first liquid crystal layer LCL1, and a touch electrode layer TE. The first substrate SUB1 and the second substrate SUB2 are overlapped with each other, and the first liquid crystal layer LCL1 is disposed between the first substrate SUB1 and the second substrate SUB2.

It should be noted that the overlapping relationship is, for example, that the first substrate SUB1 and the second substrate SUB2 overlap each other along an vertical direction of FIG. 1 (e.g., a normal direction of a surface SUB1s of the first substrate SUB1), but it is not limited thereto. If not specifically mentioned below, the overlapping relationship of the two components is defined in the same way, and the overlapping direction will not be repeated herein. The material of the first substrate SUB1 and the second substrate SUB2 may include glass, quartz, high molecular polymer (e.g., polyimide PI, polycarbonate PC, polymethyl methacrylate PMMA), or other suitable transparent plates.

The disclosure does not limit the operation mode of the first liquid crystal layer LCL1. For example, the operation mode of the first liquid crystal layer LCL1 may be twisted nematic (TN) mode, super twisted nematic (STN) mode, electrically controlled birefringence (ECB) mode, optically compensated bend (OCB) mode, in-plane switching (IPS) mode, vertical alignment (VA) mode, fringe field switching (FFS) mode, etc.

For example, the first electrically controlled liquid crystal cell 100 may further include multiple pixel electrodes PE disposed on the first substrate SUB1 and electrically independent from each other. The pixel electrodes PE may define multiple pixel regions of the touch display panel (i.e., the first electrically controlled liquid crystal cell 100). In order to individually control the pixel electrodes PE, the first electrically controlled liquid crystal cell 100 may further include multiple active elements (not shown), multiple scan lines (not shown), and multiple data lines (not shown). Each of the active elements may be electrically connected to a corresponding scan line, a corresponding data line, and a corresponding pixel electrode PE. The scan line is configured to transmit a gate driving signal for turning the active element on or off. The data line is configured to transmit a driving voltage signal that makes the pixel electrode PE have a specific potential.

The touch electrode layer TE is disposed between the first substrate SUB1 and the second substrate SUB2. In this embodiment, the touch electrode layer TE is optionally disposed on the first substrate SUB1 and located between the first substrate SUB1 and the first liquid crystal layer LCL1. That is, the first liquid crystal layer LCL1 is located between the pixel electrode PE (or the touch electrode layer TE) and the second substrate SUB2. For example, an insulating layer INS may be provided between the touch electrode layer TE and the pixel electrode PE to ensure the electrical independence therebetween.

In this embodiment, besides being used for touch sensing, the touch electrode layer TE may also be used as a common electrode of display pixels, but it is not limited thereto. For example, during a display period of the touch display panel, an electric field formed between each of the pixel electrodes PE and the touch electrode layer TE may be used to drive the first liquid crystal layer LCL1. During a touch sensing period of the touch display panel, the touch electrode layer TE is used to sense a touch motion of a user. However, the disclosure is not limited thereto. According to other embodiments, the touch electrode layer and a common electrode layer of the display pixels may be the same film layer, but they are structurally separated and electrically independent.

In this embodiment, the touch electrode layer TE and the pixel electrode PE are, for example, light-transmissive electrodes, and the material of the light-transmissive electrodes includes metal oxides, such as: indium tin oxide, indium zinc oxide, aluminum tin oxide, aluminum zinc oxide, other suitable oxides, or a stacked layer of at least two of the above.

The second electrically controlled liquid crystal cell 200 is disposed on one side of the first substrate SUB1 of the first electrically controlled liquid crystal cell 100 and overlapping the first electrically controlled liquid crystal cell 100. On the other hand, in this embodiment, the second electrically controlled liquid crystal cell 200 is, for example, an electrically controlled privacy sheet with a viewing angle switching function, but is not limited thereto. For example, the second electrically controlled liquid crystal cell 200 may include a third substrate SUB3, a fourth substrate SUB4, a second liquid crystal layer LCL2, a first electrode layer EL1, and a second electrode layer EL2. The third substrate SUB3 and the fourth substrate SUB4 are overlapped with each other, and the second liquid crystal layer LCL2 is disposed between the third substrate SUB3 and the fourth substrate SUB4. The material of the third substrate SUB3 and the fourth substrate SUB4 may include glass, quartz, high molecular polymer (e.g., polyimide PI, polycarbonate PC, polymethyl methacrylate PMMA), or other suitable transparent plates.

In detail, the third substrate SUB3 and the fourth substrate SUB4 have a first surface SUB3s and a second surface SUB4s facing each other, respectively. The first electrode layer EL1 covers the first surface SUB3s of the third substrate SUB3 entirely. The second electrode layer EL2 covers the second surface SUB4s of the fourth substrate SUB4 entirely. More specifically, the first electrode layer EL1 and the second electrode layer EL2 of this embodiment may be formed by unpatterned conductive layers. The first electrode layer EL1 and the second electrode layer EL2 are, for example, light-transmissive electrodes, and the material of the light-transmissive electrodes includes metal oxides, such as: indium tin oxide, indium zinc oxide, aluminum tin oxide, aluminum zinc oxide, other suitable oxides, or a stacked layer of at least two of the above.

In this embodiment, the fourth substrate SUB4 of the second electrically controlled liquid crystal cell 200 is located between the third substrate SUB3 and the touch electrode layer TE, and the second electrode layer EL2 may have a ground potential GND. For example, in response to the second electrically controlled liquid crystal cell 200 being enabled, an electric field formed between the first electrode layer EL1 and the second electrode layer EL2 may be used to drive the second liquid crystal layer LCL2, so that the light output field angle of the light from a backlight source (not shown) is reduced after passing through the second electrically controlled liquid crystal cell 200, thereby achieving the effect of anti-peep display. On the contrary, in response to the second electrically controlled liquid crystal cell 200 being disabled, the light output field angle of the light from the backlight source does not change substantially after passing through the second electrically controlled liquid crystal cell 200, so the display apparatus 10 may perform display operation in a normal range of viewing angle.

The disclosure does not limit the operation mode of the second liquid crystal layer LCL2. For example, the operation mode of the second liquid crystal layer LCL2 may be twisted nematic (TN) mode, super twisted nematic (STN) mode, electrically controlled birefringence (ECB) mode, optically compensated bend (OCB) mode, in-plane switching (IPS) mode, vertical alignment (VA) mode, fringe field switching (FFS) mode, etc.

Further, in this embodiment, in order to reduce the capacitive coupling effect of the touch electrode layer TE in the first electrically controlled liquid crystal cell 100 and the second electrode layer EL2 in the second electrically controlled liquid crystal cell 200, a spacer layer 150 may be disposed between the first electrically controlled liquid crystal cell 100 and the second electrically controlled liquid crystal cell 200. More specifically, the spacer layer 150 is disposed on the surface SUB1s of the first substrate SUB1 of the first electrically controlled liquid crystal cell 100 facing away from the first liquid crystal layer LCL1. For example, in this embodiment, the spacer layer 150 may be an optical adhesive layer for joining the first electrically controlled liquid crystal cell 100 and the second electrically controlled liquid crystal cell 200, and the material of the optical adhesive layer may include optical clear resin (OCR), optical clear adhesive (OCA), or other suitable optical-grade adhesive materials, but is not limited thereto.

Preferably, a film thickness t of the spacer layer 150 along the vertical direction of FIG. 1 (e.g., the normal direction of the surface SUB1s of the first substrate SUB1) may be greater than or equal to 50 μm and less than or equal to 300 μm. Through the limitation of range of the film thickness, the configuration of the spacer layer 150 may effectively suppress the capacitive coupling effect between the touch electrode layer TE and the second electrode layer EL2. Even if the first electrically controlled liquid crystal cell 100 is deformed by touch and pressure, the variation of coupling capacitance between the touch electrode layer TE and the second electrode layer EL2 may be controlled within a reasonable range without affecting the identification of a touch point.

However, the disclosure is not limited thereto. From another point of view, the spacer layer 150 may also be formed of a light-transmissive material layer with a Young's modulus greater than 22 kPa. The spacer layer 150 of the Young's modulus within the range may suppress the deformation of the first electrically controlled liquid crystal cell 100 generated when being touched or pressed, thereby reducing the variation of coupling capacitance between the touch electrode layer TE and the second electrode layer EL2, which helps to improve the touch accuracy of the display apparatus 10.

Another embodiment is described below to explain the disclosure in detail. The same components will be denoted by the same reference numerals, and the description of the same technical content will be omitted. For the description of the omitted part, reference may be made to the above embodiment, and details are not described in the following embodiment.

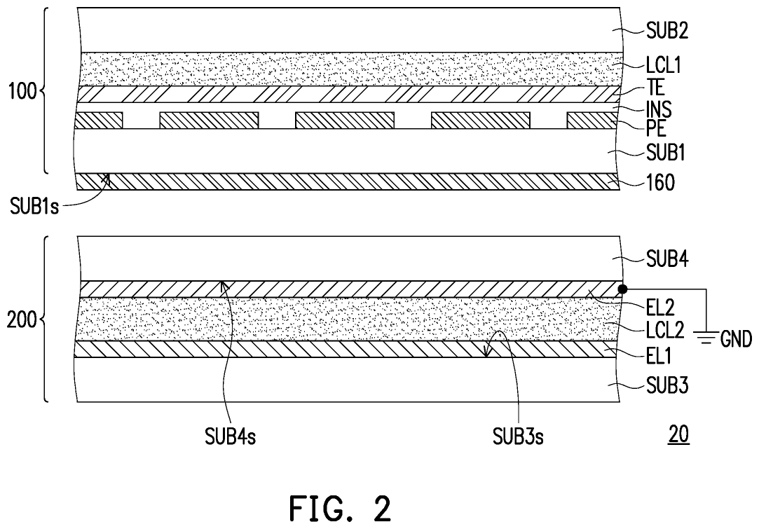

FIG. 2 is a cross-sectional schematic view of a display apparatus according to the second embodiment of the disclosure. Referring to FIG. 2, in this embodiment, in a display apparatus 20, the spacer layer 150 of the display apparatus 10 shown in FIG. 1 is replaced by a conductive layer 160. In detail, the conductive layer 160 of this embodiment is disposed on the surface SUB1s of the first substrate SUB1 of the first electrically controlled liquid crystal cell 100 away from the first liquid crystal layer LCL1. For example, in this embodiment, the conductive layer 160 may cover the surface SUB1s of the first substrate SUB1 entirely (i.e., not patterned), but not limited thereto.

It should be noted that, in this embodiment, the conductive layer 160 is not coupled to any external power or circuit, that is, the conductive layer 160 may have a floating potential. Accordingly, it is ensured that the touch electrode layer TE may perform normal touch sensing.

On the other hand, the conductive layer 160 is directly disposed on the first electrically controlled liquid crystal cell 100 and is located between the touch electrode layer TE and the second electrode layer EL2. Thus, in addition to shielding the coupling capacitance between the touch electrode layer TE and the second electrode layer EL2, the coupling capacitance between the conductive layer 160 and the touch electrode layer TE does not change significantly as being affected by the deformation of the first electrically controlled liquid crystal cell 100 caused by the touch or pressure, which helps to improve the touch accuracy of the display apparatus 20.

In this embodiment, the conductive layer 160 is, for example, a light-transmissive electrode, and the material of the light-transmissive electrode includes metal oxides (e.g., indium tin oxide, indium zinc oxide, aluminum tin oxide, aluminum zinc oxide, other suitable oxides, or a stacked layer of at least two of the above) or a thinned metal.

To sum up, in the display apparatus of an embodiment of the disclosure, the touch electrode layer is disposed inside the first electrically controlled liquid crystal cell. By the configuration of the spacer layer or the conductive layer between the first electrically controlled liquid crystal cell and the second electrically controlled liquid crystal cell, a change of a coupling capacitance of the touch electrode layer and the second electrically controlled liquid crystal cell when being touched caused by a deformation of the first electrically controlled liquid crystal cell may be avoided, which helps to improve the touch accuracy of the display apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display apparatus, comprising:
a first electrically controlled liquid crystal cell, comprising:
a first substrate and a second substrate, overlapped with each other;
a first liquid crystal layer, disposed between the first substrate and the second substrate; and
a touch electrode layer, disposed between the first substrate and the second substrate; and
a second electrically controlled liquid crystal cell, disposed on one side of the first substrate of the first electrically controlled liquid crystal cell and overlapping the first electrically controlled liquid crystal cell,
wherein a spacer layer or a conductive layer is disposed between the first electrically controlled liquid crystal cell and the second electrically controlled liquid crystal cell, and the spacer layer or the conductive layer is disposed on a surface of the first substrate facing away from the first liquid crystal layer.

2. The display apparatus according to claim 1, wherein a Young's modulus of the spacer layer is greater than 22 kPa.

3. The display apparatus according to claim 1, wherein a film thickness of the spacer layer is greater than or equal to 50 μm and less than or equal to 300 μm.

4. The display apparatus according to claim 1, wherein the spacer layer is an optical adhesive layer configured to join the first electrically controlled liquid crystal cell and the second electrically controlled liquid crystal cell.

5. The display apparatus according to claim 1, wherein the touch electrode layer is disposed on the second substrate and located between the second substrate and the first liquid crystal layer.

6. The display apparatus according to claim 5, wherein the first electrically controlled liquid crystal cell further comprises a plurality of pixel electrodes disposed on the first substrate and electrically independent from each other.

7. The display apparatus according to claim 1, wherein the conductive layer covers the surface of the first substrate entirely.

8. The display apparatus according to claim 1, wherein the conductive layer has a floating potential.

9. The display apparatus according to claim 1, wherein the second electrically controlled liquid crystal cell comprises:
a third substrate and a fourth substrate overlapped with each other and having a first surface and a second surface facing each other, respectively;
a second liquid crystal layer, disposed between the third substrate and the fourth substrate;
a first electrode layer, covering the first surface of the third substrate entirely; and
a second electrode layer, covering the second surface of the fourth substrate entirely.

10. The display apparatus according to claim 9, wherein the fourth substrate is located between the third substrate and the touch electrode layer, and the second electrode layer has a ground potential.
